(19) United States
(12) Patent Application Publication
(10) Pub. No.: US 2021/0372711 A1
(43) Pub. Date: Dec. 2, 2021

(54) PRESSURE CAPILLARY PUMP

(71) Applicant: Vladimir Vladimirovich SAKHAROV, Moscow (RU)

(72) Inventor: Vladimir Vladimirovich SAKHAROV, Moscow (RU)

(21) Appl. No.: 16/320,488

(22) PCT Filed: Jun. 21, 2018
(86) PCT No.: PCT/RU2018/000408

§ 371 Date: Jan. 25, 2019

(30) Foreign Application Priority Data
Jun. 30, 2017 (RU) 2017123150

(51) Int. Cl. F28D 15/04

(52) U.S. Cl. CPC F28D 15/043; F28D 15/046

(57) ABSTRACT

The invention relates to two-phase heat transfer devices based on a closed evaporation-condensation cycle wherein the circulation of a working fluid is provided by capillary forces. The pressure capillary pump (PCP) according to the invention comprises a sealed housing having an inner cavity divided with a lyophobic capillary-porous partition into an evaporator cavity and a condenser cavity. A wick is arranged in the evaporator cavity. The condenser and evaporator cavities are mutually connected with a pipeline system to form a closed loop. The housing is filled with a two-phase working fluid, wherein a porous space of the wick, the condenser cavity and the pipeline system are filled with the liquid phase, and the space between the wick and the lyophobic partition is filled with saturated vapor. The housing may be made in the form of two cylindrical shells arranged coaxially to form an annular cavity, wherein a heat-generating source is arranged along the axis of the shells. To directly convert the thermal energy into the electric one, the PCP may comprise a liquid-metal MHD generator, wherein the housing is filled with a working fluid in the form of a liquid metal. The technical result consists in an increase in pressure and more efficient conversion of the thermal energy into the mechanical energy of the liquid working fluid flow.

The invention relates to the field of heating engineering and, more specifically, to two-phase heat-transfer devices based on a closed evaporation-condensation cycle wherein the circulation of a working fluid is provided by capillary forces.

A heat transfer device is known (the heat pipe suggested by G. M. Grover), the device comprising a container having condenser and evaporator regions. The container encloses a condensable vapor consisting of lithium, a capillary means (a wick), said capillary means covering the entire inner surface of the container except for a portion of the condensing region. The quantity of the condensable vapor present is just sufficient to saturate the capillary means when condensed and provide a small excess, said capillary means capable of causing the transport of the condensed vapor from the cooler area of the container to the hotter area thereof (U.S. Pat. No. 3,229,759, published Jan. 18, 1966, Cl. F28D 15/04, G21C 15/02, G21C 15/257).

Further a heat pipe for non-wetting fluids is known, the heat pipe comprising casing means defining a closed chamber, capillary means so disposed in said chamber as to provide a space between said capillary means and said casing, and a fluid which is non-wetting with respect to said capillary means being disposed in said space (U.S. Pat. No. 3,435,889, published Apr. 1, 1969, Cl. F28D 15/04).

Further a loop heat pipe is known, comprising a sealed housing having evaporating and condensing areas that are provided with a capillary-porous filler wetted with a heat-transfer agent, and are mutually connected by a vapor pipeline and a condensate pipeline (SU Author's Certificate No. 449213, Cl. F28D 15/00, published Nov. 5, 1974).

Both in a conventional heat pipe and in a loop heat pipe, a capillary-porous structure (a wick) wetted with a heat-transfer agent serves as a capillary pump by which condensate is transferred from the area being cooled to the area being heated. Such a capillary pump is substantially limited to the liquid pressure it provides as the pores in the wick are closed with bubbles being formed when the working fluid boils.

One object of the present invention is to provide a pressure capillary pump (PCP) allowing not only to provide a closed loop circulation of working fluid in two-phase heat-transfer devices, but also to provide mechanical energy excess of the liquid working fluid flow enough for obtaining useful work.

Another object of the present invention is to provide a capillary condensing heat exchanger, wherein the heat is removed from vapor and the saturated vapor condenses on the surfaces of convex menisci of the liquid, the pressure in the liquid being higher than the pressure of the saturated vapor.

These objects are achieved with a PCP that comprises a sealed housing comprising a wall being heated and a wall being cooled, and a lyophobic capillary-porous partition that divides the inner cavity of the sealed housing into an evaporator cavity and a condenser cavity. A wick is arranged in the evaporator cavity, the wick being in thermal contact with an inner surface of the wall being heated. The condenser and evaporator cavities are mutually connected with a pipeline system to form a closed loop. The housing is filled with a single-component two-phase working fluid, wherein a porous space of the wick, the condenser cavity and the pipeline system are filled with the liquid phase, and the space between the wick and the lyophobic partition is filled with the saturated vapor.

The housing may be made in the form of two cylindrical shells arranged coaxially to form an annular cavity, wherein a heat-generating source is arranged along the axis of the shells.

To convert the thermal energy directly into the electric one, the PCP may comprise at least one liquid-metal MHD generator, wherein the housing is filled with a working fluid in the form of a liquid metal.

The technical result achieved consists in increasing the pressure provided with the PCP, as well as in increasing the efficiency when converting the thermal energy into the mechanical energy of the liquid working fluid flow.

The invention as claimed is explained with a reference to accompanying drawings, wherein:

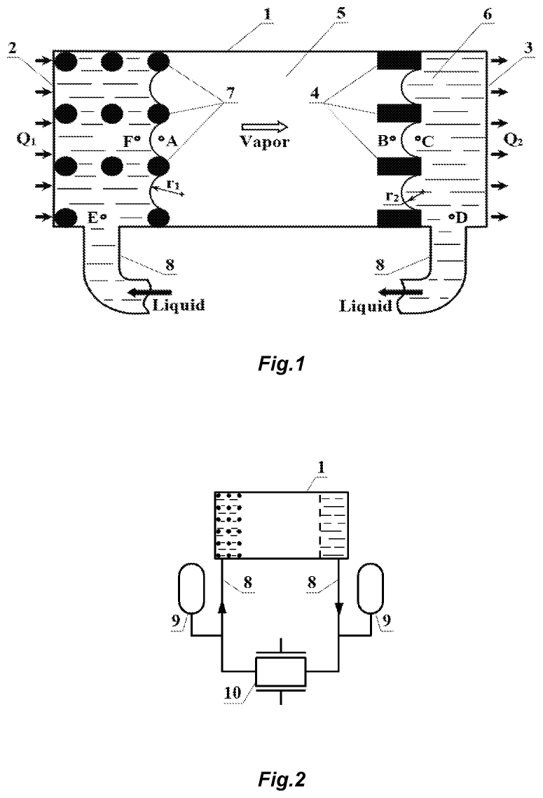

FIG. 1 schematically shows the operation principle of the PCP.

FIG. 2 shows a schematic diagram of a heat-and-power apparatus based on the PCP.

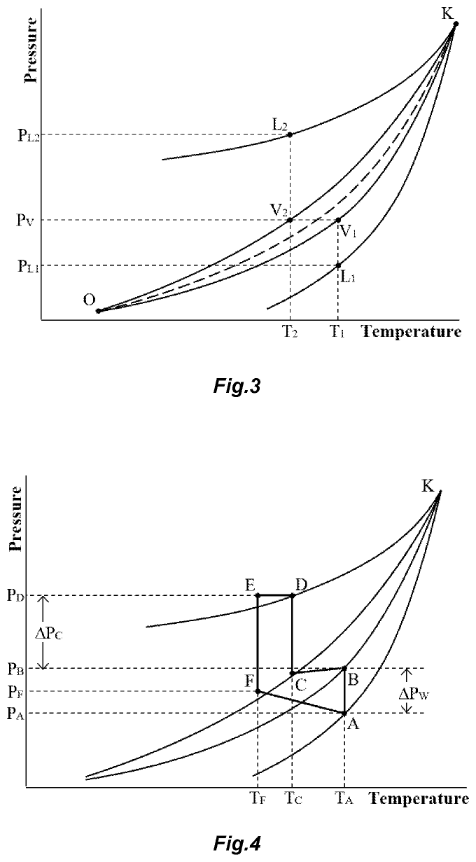

FIG. 3 shows a state phase diagram of a single-component two-phase system.

FIG. 4 shows a diagram of the thermodynamic cycle of the PCP.

A PCP comprises a sealed housing 1 comprising a wall 2 being heated and a wall 3 being cooled, and a lyophobic capillary-porous partition 4 that divides an inner cavity of the sealed housing into an evaporator cavity 5 and a condenser cavity 6. A wick 7 is arranged in the evaporator cavity, the wick being in thermal contact with an inner surface of the wall 2 being heated. The condenser and evaporator cavities are mutually connected with a pipeline system 8 to form a closed loop. The housing is filled with a single-component two-phase working fluid, wherein a porous space of the wick 7, the condenser cavity 6 and the pipeline system 8 are filled with the liquid phase, and the space between the wick 7 and the lyophobic partition 4 is filled with saturated vapor.

The housing 1 may be made in the form of two cylindrical shells arranged coaxially to form an annular cavity, wherein a heat-generating source (not shown in the figures) is arranged along the axis of the shells.

To convert the thermal energy directly into the electric one, the PCP may comprise at least one liquid-metal MHD generator 10, and vessels 9 for accumulating energy of the working fluid under pressure, the housing 1 being filled with a working fluid in the form of a liquid metal.

The operation of the PCP according to the invention is based on thermodynamics rules for surface phenomena of single-component two-phase “liquid-vapor” systems with a constant total volume. A liquid contained in the porous space of the wick forms an interfacial surface having an average curvature radius r₁<0 (a concave meniscus). A liquid contained in the condenser and separated from the evaporator cavity by the lyophobic capillary-porous partition forms an interfacial surface having an average curvature radius r₂>0 (a convex meniscus).

Such a system can be in mechanical equilibrium on curved interfacial surfaces provided that the temperature at the interface with the concave meniscus is higher than the temperature at the interface with the convex meniscus. Otherwise, there will be a pressure difference and corresponding vapor flows between the parts of different surface curvature (when the temperatures are equal, vapor will leave the surface of higher curvature and condense on the surface of lower curvature).

The excess hydrostatic pressure (capillary pressure) ΔP that occurs in a liquid when the mechanical equilibrium with its saturated vapor on the curved interfacial surface has been reached is determined with the Young-Laplace equation ΔP=2σ/r₂, wherein a is surface tension, r₂ is an average curvature radius of an interfacial surface.

At a certain temperature T, an equilibrium pressure of saturated vapor P_{V} is observed above the curved interfacial surface of the liquid, the pressure being determined with sufficient accuracy according to the Kelvin equation P_{V}=P₀exp(2σVₘ/r₂RT), wherein P₀ is the equilibrium pressure of the vapor above the flat interfacial surface at a temperature T, Vₘ is the molar volume of the liquid phase, and R is the universal gas constant.

The phase transition between the saturated vapor and the liquid phase takes place when there is a strictly defined relation between the working fluid pressure and temperature.

A phase diagram illustrating a state of the single-component two-phase system, along the axes of pressure P and temperature T, is shown in FIG. 3.

The curve of the vapor saturation above the flat phase interface is shown with a dotted line connecting the triple point O with the critical point K.

The curve of the vapor saturation above the concave meniscus having an average curvature radius r₁ is shown by the line extending from the critical point K through the point V₁, and the dependence of the pressure in the liquid is shown by the line extending from the critical point K through the point L₁. At the temperature T₁, the saturated vapor above the concave meniscus is in equilibrium with the liquid if its state corresponds to the point V₁ and the state of the liquid corresponds to the point L₁. Wherein, the pressure of the saturated vapor is equal to P_{V}, and the pressure in the liquid is equal to P_{L1}.

The curve of the vapor saturation above the convex meniscus having an average curvature radius r₂ is shown by the line extending from the critical point K through the point V₂, and the dependence of the pressure in the liquid is shown by the line extending from the critical point K through the point L₂. At the temperature T₂, the saturated vapor is in equilibrium with the liquid if its state corresponds to the point V₂ and the state of the liquid corresponds to the point L₂. Wherein, the pressure of the saturated vapor is equal to P_{V}, and the pressure in the liquid is equal to P_{L2}.

If in the single-component two-phase system there are two isolated liquid volumes (i.e., the liquid is prevented from flowing from one volume to the other) and the saturated vapor can freely flow between the interfacial surfaces of different curvature, then the system will be in dynamic equilibrium only if the pressure of the saturated vapor above the interfacial surfaces is the same and equals to P_{V}. Such a pressure balance of the saturated vapor above the menisci of different curvature is reached when there is corresponding temperature difference on these menisci. Under dynamic equilibrium, the temperature of the saturated vapor above the concave meniscus having an average radius r₁ will be equal to T₁, and the temperature of the saturated vapor above the convex meniscus having an average radius r₂ will be equal to T₂.

When the convex meniscus is cooled to a temperature less than T₂ and/or the concave meniscus is heated to a temperature higher than T₁, the vapor will immediately begin to condense on the convex interfacial surface, while evaporation will begin from the concave meniscus. Thereby, the working fluid will be transferred from the lower pressure P_{L1} liquid volume to the higher pressure P_{L2} liquid volume.

The PCP operates in the following way. In the initial state, the PCP is filled with a single-component two-phase working fluid, the liquid phase of which is in the condenser cavity 6 and the pipeline system 8, as well as in the porous space of the wick 7. When the wall 2 being heated of the housing 1 is externally supplied with heat by the heat-generating source, the heat is transferred to the liquid working fluid which is in the porous space of the wick 7 and evaporates through the interfacial surface. As the amount of the liquid in the porous space of the wick decreases, an interfacial surface having a negative average curvature radius r₁<0 (a concave meniscus) is formed. The vapor of the working fluid from the evaporation surface enters the vapor space of the evaporator cavity 5 and then condenses on the interfacial surface in the condenser cavity 6 due to the heat removal from the wall 3 being cooled after its passing through the capillary pores of the lyophobic partition 4. As the amount of the liquid in the condenser cavity increases, an interfacial surface having a positive average curvature radius r₂>0 (a convex meniscus) is formed. The heat released in this case (condensation heat) is removed from the outer surface of the wall 3 being cooled due to the heat exchange with the cooling medium or the surface radiation.

Through the pipeline system 8, the liquid working fluid condensed in the condenser cavity 6 enters the MHD generator 10 where it does work, and then returns to the evaporator cavity 5 where the process is repeated.

The P-T diagram shown in FIG. 4 clearly illustrates a circulation process taking place during the operation described above. The cycle is started in the point A that corresponds to the state of the liquid working fluid, below the concave meniscus, after being supplied with heat in the evaporator. The evaporation of the working fluid takes place in the point B, wherein at the interface of the two phases separated by a curved surface the pressure jumps across the interface by a value of the capillary pressure ΔP_{W}. The vapor produced moves into the condenser where it is cooled to the state of the point C corresponding to the state of the saturated vapor above the convex meniscus. The working fluid condensation takes place in the point D, wherein at the interface of the two phases separated by a curved surface the pressure jumps across the interface by a value of the capillary pressure ΔP_{C}. The condensed working fluid is slightly overcooled in the condenser to the state of the point E. The liquid working fluid that is under the pressure P_{D} may be used for actuating mechanisms and machines, as well as for converting kinetic energy of a liquid into electric energy by means of the MHD generator.

After throttling, the pressure in the liquid working fluid decreases, and the working fluid that is in the state corresponding to the point F is fed through the inlet of the PCP into the evaporator. To prevent vapor bubbles from forming in the pipeline system, the pressure P_{F} should not be less than the pressure of the saturated vapor above the flat surface at the temperature T_{F}. In the evaporator, when the liquid working fluid passes through the capillary structure of the wick, the liquid is heated and the pressure of the working fluid decreases to a certain extent to the state A, and the working fluid returns to its initial state.

Thus, the PCP allows for mechanical energy excess of the liquid working fluid flow a closed loop circulation of working fluid in two-phase heat-transfer devices and for using the mechanical energy excess of the liquid working fluid flow for obtaining useful work.

1. A pressure capillary pump, characterized in that it comprises a sealed housing comprising a wall being heated and a wall being cooled, a lyophobic capillary-porous partition that divides an inner cavity of the sealed housing into an evaporator cavity and a condenser cavity, a wick arranged in the evaporator cavity and being in thermal contact with the inner surface of the wall being heated, a pipeline system connecting the condenser cavity with the evaporator cavity to form a closed loop, wherein the housing is filled with a single-component two-phase working fluid, wherein the porous space of the wick, the condenser cavity and the pipeline system are filled with a liquid phase of the working fluid, while a part of the evaporator cavity between the wick and the lyophobic capillary-porous partition is filled with saturated vapor of the working fluid.

2. The pressure capillary pump of claim 1, characterized in that the housing may be made in the form of two cylindrical shells made of a heat-conductive material and arranged coaxially to form an annular cavity having closed ends, wherein a heat-generating source is arranged along the axis of the shells.

3. The pressure capillary pump of claim 1, characterized in that the pump comprises at least one liquid-metal MHD generator, wherein the housing is filled with a working fluid in the form of a liquid metal.
